(19) United States
(12) Patent Application Publication
(10) Pub. No.: US 2026/0101910 A1
(43) Pub. Date: Apr. 16, 2026

(54) SEAFOOD PET FOOD WITH IMPROVED PALATABILITY AND PRESERVABILITY, AND METHOD FOR PREPARING THEREOF

(71) Applicant: Donghaehyeongsea Co., Ltd, Goseong-gun (KR)

(72) Inventor: Eun Yul KIM, Goseong-gun (KR)

(21) Appl. No.: 19/360,917

(22) Filed: Oct. 16, 2025

(30) Foreign Application Priority Data
Oct. 16, 2024 (KR) 10-2024-0141465

(51) Int. Cl. A23K 10/22; A23K 30/20; A23K 50/40

(52) U.S. Cl. CPC A23K 10/22; A23K 30/20; A23K 50/40

(57) ABSTRACT

The pet food according to exemplary embodiments of the present disclosure includes an aquatic product, and an amine compound, an acetate compound, and an acetone compound may be detected when measured using a gas chromatography-mass spectrometer. Therefore, the pet food can stimulate olfactory sense, arouse curiosity, and enhance palatability of companion animals.

### CROSS-REFERENCE TO RELATED APPLICATION

This application claims priority under 35 U.S.C § 119 to Korean Patent Application No. 10-2024-0141465 filed in the Korean Intellectual Property Office on Oct. 16, 2024, the entire contents of which are hereby incorporated by reference.

### TECHNICAL FIELD

The present invention relates to pet food and a method of producing the same. More specifically, it relates to pet food with improved palatability for companion animals and preservation properties, and a method of producing the same.

### BACKGROUND ART

Pet food refers to all food, including staple foods and snacks, consumed by companion animals such as dogs and cats. A companion animal is defined as an animal, such as a dog or cat, kept for companionship purposes, as defined by the Ministry of Agriculture, Food and Rural Affairs Ordinance.

With rising economic standards and changing demographics, there is increasing interest in companion animals, leading to the recent emergence of the new term “pet humanization.” Pet humanization refers to the social and cultural phenomenon of treating companion animals as family or friends. As this trend spreads, pet food is becoming diversified, much like human food. In particular, consumers seeking more special and premium foods for their companion animals are increasing, and many caregivers are seeking healthy and fresh food to help their companion animals live long and healthy lives. Consequently, technological development for premium pet food is also actively underway.

For example, Korean Patent Publication No. 10-1659345 is directed to a diet food for pet and its manufacturing method, and it relates to a technology that utilizes herbal medicines and functional raw materials to enhance the weight loss effect and other additional health functions for pets while improving overall palatability.

For example, Korean Patent Publication No. 10-2061431 relates to a manufacturing method of a functional food for pets and a functional food for pets manufactured thereby, characterized in that the nutritional components of natural ingredients can be preserved and palatability is significantly improved.

### DISCLOSURE OF INVENTION

### Technical Problem

One object of the present invention is to provide a pet food that stimulates the olfactory and tactile senses of companion animals, resulting in superior palatability, and allows for long-term preservation.

Another object of the present invention is to provide a method for producing a pet food that stimulates the olfactory and tactile senses of companion animals, resulting in superior palatability, and allows for long-term preservation.

### Technical Solution

A pet food according to an exemplary embodiment may include an aquatic product, and an amine compound, an acetate compound, and an acetone compound may be detected when measured using a gas chromatography-mass spectrometer.

In one embodiment, the amine compound may include at least one selected from methylamine, ethylamine, butylamine, hexylamine, dimethylamine, diethylamine, dibutylamine, and trimethylamine.

In one embodiment, the acetate compound may include at least one selected from methyl acetate, ethyl acetate, propyl acetate, butyl acetate, isoamyl acetate, and benzyl acetate.

In one embodiment, a sulfide compound may further be detected.

In one embodiment, the sulfide compound may include at least one selected from dimethyl sulfide, diethyl sulfide, methyl ethyl sulfide, dimethyl disulfide, diallyl sulfide, and diphenyl sulfide.

In one embodiment, the aquatic product may contain no other ingredients.

A pet food according to an exemplary embodiment may include an aquatic product, and the pet food may have a hardness, a gumminess, and a chewiness of 1,000 gf or more based on a texture profile analysis.

A method of producing a pet food according to an exemplary embodiment may include: a step of first freezing an aquatic product; a step of thawing the frozen aquatic product; a step of hot-air drying the thawed aquatic product; a step of secondarily freezing the hot-air dried aquatic product; and a step of retorting the secondarily frozen aquatic product.

In one embodiment, the hot-a000ir drying may be carried out at 50 to 70° C. for two to five hours.

In one embodiment, the step of retorting may be carried out at 110 to 130° C. for one to three hours.

### Advantageous Effects

The above and other objects, features and advantages of the present invention will become more apparent to those of ordinary skill in the art by describing exemplary embodiments thereof in detail with reference to the accompanying drawings, in which:

### BRIEF DESCRIPTION OF THE DRAWINGS

FIG. 1 shows a schematic diagram illustrating a pet food production method according to an exemplary embodiment.

FIG. 2 shows the results of analyzing pet foods according to examples and comparative examples using a gas chromatography-mass spectrometer.

FIG. 3 shows a graph illustrating the results of a hardness analysis in a texture profile analysis of pet foods according to examples and comparative examples.

FIG. 4 shows a graph illustrating the hydrogen ion concentration (pH) of pet foods according to examples and comparative examples.

FIG. 5 shows a graph illustrating the results of a volatile basic nitrogen (VBN) analysis of pet foods according to examples and comparative examples.

### BEST MODE FOR CARRYING OUT THE INVENTION

The advantages and features of the present invention and methods for achieving them will become apparent with reference to the embodiments described in detail below together with the accompanying drawings. However, the present invention is not limited to the embodiments disclosed below, but may be implemented in various different forms

In order to clearly explain embodiments of the present invention, parts that are not related to the description may be omitted. Further, in the description of the present invention, when it is determined that the detailed description of known features or functions would obscure the gist of the present invention, the description thereof will be omitted.

In describing components herein, terms such as “first,” “second,” and the like may be used. These terms are intended to distinguish one component from another for convenience of description, and unless otherwise specified, the nature, order, and the like of the components are not limited by these terms.

In each of the steps mentioned herein, unless the context clearly dictates a specific order, the steps may be performed in a different order than stated. In other words, the steps may be performed in the same order as stated, may be performed substantially simultaneously, or may be performed in the opposite order.

The expression “and/or” as used herein may mean each of the listed components and any combination of two or more of the listed components. For example, “A, B, and/or C” may be used with the same meaning as “at least one of A, B, and C.”

A pet food according to exemplary embodiments includes an aquatic product, and an amine compound, an acetate compound, and an acetone compound may be detected when measured using a gas chromatography-mass spectrometer. A pet food according to exemplary embodiments may have a hardness, a gumminess, and a chewiness of 1,000 gf or more based on a texture profile analysis. Therefore, the pet food stimulates the olfactory and texture senses of companion animals, thereby providing excellent palatability. In addition, it has excellent taste and nutrition. For example, the original form of the aquatic product can be maintained, thereby minimizing nutrient destruction and transparently providing the included ingredients.

A pet food according to one embodiment may include an aquatic product. The aquatic product may be preserved in its original form. The aquatic product may include red-fleshed fish and white-fleshed fish. Red-fleshed fish may include, for example, halibut, saury, mackerel, tuna, yellowtail, and salmon. White-fleshed fish may include, for example, cod, pollack, yellow croaker, Miiuy croaker, flatfish, flounder, sea bream, sea bass, pufferfish, and red sea bream.

According to another example, the aquatic product may include anything that companion animals may eat. Examples include cod, salmon, flatfish, yellowtail, sea bass, trout, Siberian dace, mullet, pollack, sea bream, halibut, rockfish, Spanish mackerel, smelt, sardines, shellfish, and other fish and shellfish, but is not limited thereto.

In one embodiment, the aquatic product may contain no other ingredients. For example, additives, supplements, preservatives, and other ingredients that may be artificially added as pet food ingredients may be excluded. However, due to the nature of aquatic products obtained from the sea, some salt or seawater components may be included.

In some embodiments, the aquatic product may be preserved in its original form. For example, the aquatic product may be prepared into fillets, removing bones, internal organs, and head, leaving only the flesh and some skin. The filleted aquatic product may be hot-air-dried and then retorted.

In a pet food according to one embodiment, an amine compound, an acetate compound, and an acetone compound may be detected when measured using a gas chromatography-mass spectrometer. In order to identify components that stimulate the olfactory sense and enhance preference of companion animals, the pet food according to an exemplary embodiment may be analyzed using a gas chromatography-mass spectrometer. As a result of analysis using a gas chromatography-mass spectrometer, it was confirmed that the olfactory sense of companion animals was stimulated and their preference was enhanced when an amine compound, an acetate compound, and an acetone compound were detected. Companion animals have a much larger number of olfactory receptors than humans and thus are capable of sensitively reacting to odors. In addition, scents that humans avoid may actually attract the attention of companion animals. For example, a high level of volatile basic nitrogen (VBN) may attract the interest and attention of companion animals.

Amine compounds have odors similar to ammonia, fish, and rotten meat, and their scents may stimulate the olfactory sense of companion animals and arouse their interest. While amine compounds may be unpleasant to humans, they may rather stimulate the desire for exploration in companion animals. For example, companion animals prefer their caregivers' feet smell.

In one embodiment, the amine compound may include at least one selected from methylamine, ethylamine, butylamine, hexylamine, dimethylamine, diethylamine, dibutylamine, and trimethylamine. Preferably, it may include diethylamine.

Acetate compounds have a fruity, sweet scent, which may draw the attention of companion animals. In one embodiment, the acetate compound may include at least one selected from methyl acetate, ethyl acetate, propyl acetate, butyl acetate, isoamyl acetate, and benzyl acetate. Preferably, it may include ethyl acetate.

Acetone compounds have a sweet, pungent odor and are highly volatile, so that they may disperse easily through the air. Their odors may differ slightly from those of natural foods, which can arouse the curiosity of companion animals.

In one embodiment, a sulfide compound may further be detected in the pet food when measured using a gas chromatography-mass spectrometer.

Sulfide compounds have odors similar to spoiled meat, fish, and aquatic products and may easily disperse into the air, potentially attracting companion animals. In one embodiment, the sulfide compound may include at least one selected from dimethyl sulfide, diethyl sulfide, methylethyl sulfide, dimethyl disulfide, diallyl sulfide, and diphenyl sulfide.

Preferably, it may include dimethyl sulfide.

In the pet food according to some embodiments, some terpene compounds (e.g., α-pinene, β-pinene, 3-carene, D-limonene) may not be detected when measured using a gas chromatography-mass spectrometer.

In another other embodiment, some aldehydes (e.g., acetaldehyde, 2-methyl butanal), some ketones (e.g., 2,3-pentadione), and some alcohols (e.g., ethanol) may be detected in the pet food when measured using a gas chromatography-mass spectrometer. The detected components may vary depending on the type of aquatic product being measured.

The pet food according to exemplary embodiments may have a hardness, a gumminess, and a chewiness of 1,000 gf or more based on a texture profile analysis.

Hardness may be a physical property representing the resistance required for a food to begin to deform. It may be a measurement of the initial resistance force exerted when the food is pressed or chewed. For example, it may refer to the hardness or firmness of the food.

Gumminess may be a property representing the stickiness and toughness of the food when chewed. For example, it may refer to the toughness and difficulty of chewing the food's texture.

Chewiness may refer to the total energy required to completely chew and swallow food. For example, it may refer to the length of time required to chew before swallowing.

In some embodiments, the pet food may have a hardness, a gumminess, and a chewiness of 1,000 gf or more and 5,000 gf or less based on a texture profile analysis. Preferably, the hardness may be 1,000 gf to 3,000 gf. Within this range, the pet food may provide a texture preferred by companion animals, thereby enhancing palatability.

In some embodiments, the pet food may have a hydrogen ion concentration (pH) of 6.3 or higher. Generally, a hydrogen ion concentration of 6.3 or higher in aquatic products indicates excellent freshness, a pH of 5.9 to 6.2 indicates good freshness, a pH of 5.8 indicates average freshness, a pH of 5.5 to 5.7 indicates musty odor, and a pH of 5.2 or lower indicates putrid freshness (Pottinger, S. R. (1948). Some data on pH and the freshness of shucked eastern oysters. Comm. Fisheries). The pet food may be provided fresh after hot-air drying and retort processing, as the pH is 6.3 or higher.

In some embodiments, the pet food may have a VBN value of 50 mg % or higher. For example, it may be 55 mg % or more, 60 mg % or more, 65 mg % or more, 70 mg % or more, or 75 mg % or more. According to the 2023 standards of the Ministry of Food and Drug Safety, the VBN freshness limit is generally 20 mg %. However, aquatic products (e.g., fish meat) may be excluded from the VBN determination due to its high urea content and high ammonia production. However, regardless of spoilage, when the VBN value of the pet food according to one embodiment is measured, it may be 50 mg % or more. The measured VBN may be an off-flavor generated in the process in which proteins, carbohydrates, fats, and the like are deteriorated and changed into amine compounds, ketone compounds, and carbonyl compounds by the action of microorganisms or enzymes inherent in fish. The VBN value may a significant numerical value that stimulates the olfactory sense of companion animals and improves their palatability.

A method of producing a pet food according to an exemplary embodiment may include: a step of first freezing an aquatic product; a step of thawing the frozen aquatic product; a step of hot-air drying the thawed aquatic product; a step of secondarily freezing the hot-air dried aquatic product; and a step of retorting the secondarily frozen aquatic product.

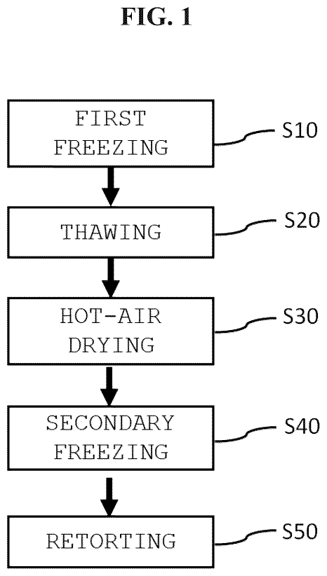

Referring to FIG. 1, the aquatic product may first be subjected to first freezing (e.g., S-10). The aquatic product may be pre-processed prior to first freezing. For example, the aquatic product may be filleted, removing bones, internal organs, and head, leaving only the meat and some skin. The filleted aquatic product may be washed several times in fresh water. Washing may be performed solely in fresh water, excluding additional ingredients. Additional ingredients may include minerals, plant extracts, and the like. Washing solely in fresh water helps remove only salt while maintaining the nutritional value of the aquatic product.

The washed aquatic product may be subjected to first freezing at −30 to −10° C. This freezing process may maintain the freshness of the aquatic product, suppress bacterial growth, and enhance storage and transport convenience. The above-described details may be applied equally to the specific details of the aquatic product.

Next, the frozen aquatic product may be thawed (e.g., S-20).

The thawing may be performed using a low-temperature, flowing-water method using fresh water. For example, the frozen aquatic product may be thawed by running fresh water at 0 to 15° C. for 30 to 90 minutes. This low-temperature, flowing-water method ensures uniform thawing, maintaining freshness while removing residual salt.

Next, the thawed aquatic product may be subjected to hot-air drying (e.g., S-30). Hot-air drying may be carried out at 50 to 70° C. for one to five hours. Within this range, moisture may be efficiently removed, and the food may be dried evenly. Hot-air drying for longer than this time may result in excessive loss of moisture and a decrease in color.

When a retorting step described below is performed after hot-air drying, a texture (e.g., hardness, gumminess, and chewiness) highly favored by companion animals may be provided. For example, hardness, gumminess, and chewiness according to a texture profile analysis may be between 1,000 gf and 5,000 gf, preferably between 1,000 gf and 3,000 gf. Therefore, performing both hot-air drying and retort processing may be essential to improving the physical properties of the pet food.

Next, the hot-air-dried aquatic product may be subjected to secondary freezing (e.g., S-40). The hot-air-dried aquatic product may be subjected to secondary freezing at temperatures ranging from −30° C. to −10° C. Secondary freezing may reduce microorganisms and maintain texture. In addition, it may preserve nutrients and maintain freshness.

Next, the secondarily frozen aquatic product may be retorted (e.g., S-50).

Retorting may be a high-temperature sterilization step for long-term food preservation. The secondarily frozen aquatic product may be sealed in various packaging materials, such as plastic film, metal cans, and glass bottles, and sterilized at high temperatures.

In one embodiment, the retorting step may be carried out at 110 to 130° C. for 1 to 3 hours. Preferably, the retorting step can be performed at 115 to 125° C. for two to three hours. Within this range, the pet food may provide a texture (e.g., hardness, gumminess, and chewiness) highly favored by companion animals. In addition, since the pet food may be stored at room temperature, its storability and portability may be improved, and its shelf life may be extended to 6 to 12 months. In addition, the moisture content may be controlled between 4% and 60%.

Since an amine compound, an acetate compound, and an acetone compound is detected when measured using a gas chromatography-mass spectrometer, the pet food produced according to an exemplary embodiment can stimulate the olfactory sense of companion animals, thereby improving their palatability. In addition, it has excellent taste and nutrition. For example, the original form of the aquatic product can be maintained, thereby minimizing nutrient destruction and transparently providing the included ingredients.

Hereinafter, preferred embodiments and comparative examples of the present invention are described. However, the following examples are only preferred embodiments of the present invention, and the present invention is not limited to the following examples.

### EXAMPLES

Domestic salmon was preprocessed and prepared into fillets. The filleted salmon was washed in fresh water, frozen at −18° C., and then flowing-water thawed in fresh water for approximately 50 minutes. The thawed salmon was dried in a hot-air dryer at approximately 64° C. for two hours. The dried salmon was then refrozen in a freezer at −18° C. The retorting machine was preheated at approximately 120° C. and 1.5 bar for 15 minutes. The fully frozen salmon was placed in a retort plastic film and placed in the retorting machine and sterilized at a high temperature for approximately two hours. The salmon was then stored at room temperature.

### Comparative Example 1

“Juicy Real Salmon Whole Meat” product produced by Pet Pound was prepared.

### Comparative Example 2

“Salmon Kung” product produced by PS Korea was prepared.

### Experimental Example 1: Gas Chromatography-Mass Spectroscopy (GC-MS) Analysis

The pet foods prepared in Example 1 and Comparative Example 1 were analyzed by gas chromatography-mass spectrometry (GC-MS) under the conditions shown in Table 1.

TABLE 1

| GC | Thermo Trace GC | MS | Thermo MS |
|---|---|---|---|
| | Ultra Ver. 5.0 | | DSQ II |
| Column | DB-5MS UI column (30 m × 0.25 mm i.d. × 0.25 μm) | | |
| Carrier gas | 99.999% helium | Flow rate | 1.0 mL/min |
| | Rate | Temp. | Hold |
| GC Oven | (° C./min) | (° C.) | time(min) |
| Initial | — | 40 | 5 |
| Ramp 1 | 5 | 200 | 5 |
| Ramp 2 | 5 | 250 | 5 |
| Fiber | 75 μm Carboxen/Polydimethylsiloxane (CAR/PDMS) | | |
| Sample weight | 2 g (+25% NaCl solution 1 mL) | | |
| Equilibration | 40° C., | Adsorption | R.T, |
| | 30 min(Shaking | | 10 min |
| | for 200 rpm) | | |

| | |
|---|---|
| Desorption | 220° C., splitless mode for 10 min |
| Temp | MS transfer line temp, ion source temp: 230° C. |
| Scan mode | full scan (mass range: 15-450 m/z) |

In addition, 20 ML of 4-methyl-2-pentanol was added as an internal standard (IS), and the concentrations of volatile components were calculated using Formula 1 and presented in Table 2.

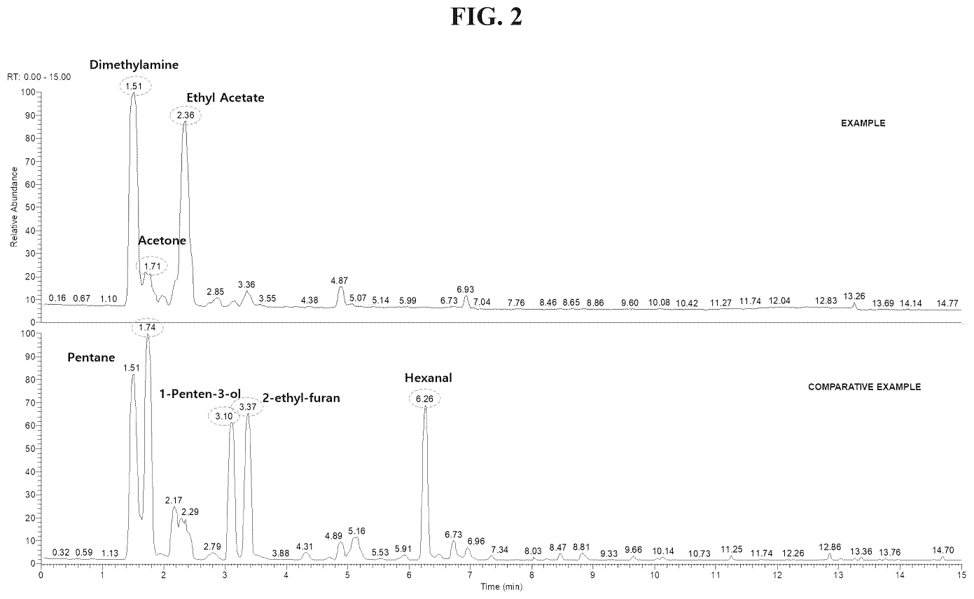

Graphs with the relative amounts of volatile components on the y-axis are shown in FIG. 2.

$$\frac{Peak area ratio ( \frac{compound}{I . S} ) * 2 ug ( I . S )}{2 g ( samples )} \qquad [ Formula 1 ]$$

TABLE 2

| | | | | Comparative | |
|---|---|---|---|---|---|
| | RT | RI | Example | Example 1 | Description |
| 1-Penten-3-ol | 3.10 | 683 | 0.25 ± 0.08 | 7.17 ± 0.59 | Pungent, green |
| 1-Pentanol | 5.16 | 765 | — | 1.75 ± 0.19 | Balsamic, fermented |
| 1-Octen-3-ol | 13.04 | 980 | — | 0.06 ± 0.02 | Mushroom |
| Ethyl Acetate | 2.36 | 612 | 11.75 ± 1.92 | 1.66 ± 0.07 | Brandy, ethereal, fruity |
| 2-methyl Propanal | 1.99 | 552 | 0.43 ± 0.03 | — | Aldehydic, fresh, floral |
| Butanal | 2.17 | 593 | — | 2.97 ± 0.25 | Pungent, cocoa, musty, |
| | | | | | green |
| 2-methyl-Butanal | 2.87 | 662 | 0.53 ± 0.09 | — | Musty, cocoa |
| Hexanal | 6.26 | 801 | — | 6.69 ± 0.76 | green, leafy, fruity |
| 2-methyl-2- | 7.34 | 837 | — | 0.16 ± 0.02 | Aldehydic, fruity, green |
| Pentenal | | | | | |
| (E)-2-Hexenal | 8.25 | 854 | — | 0.05 ± 0.01 | Green, apple |
| (E)-4-Heptenal | 10.05 | 900 | — | 0.06 ± 0.01 | Green, fatty |
| Heptanal | 10.14 | 901 | — | 0.10 ± 0.04 | Sharp citrus, |
| | | | | | Aldehydic/fatty |
| Octanal | 13.85 | 1003 | — | 0.03 ± 0.00 | Fatty, citrus |
| Pentane | 1.74 | 500 | — | 17.80 ± 5.99 | Gasoline/sweet |
| 2,4-dimethyl - | 7.06 | 821 | 0.03 ± 0.02 | — | — |
| Heptane | | | | | |
| 4-methyl-Octane | 8.68 | 863 | 0.03 ± 0.01 | — | — |
| Acetone | 1.71 | 487 | 1.29 ± 0.12 | — | Pungent, solvent, apple, |
| | | | | | pear |
| 2,4-Octadiene | 6.73 | 818 | — | 0.85 ± 0.12 | — |
| Dimethyl sulfide | 1.78 | 520 | 1.18 ± 0.10 | — | Fishy, sulfurous, |
| | | | | | cabbage |
| Toluene | 5.07 | 763 | 0.17 ± 0.05 | — | Sweet, pungent, benzene |
| Ethylbenzene | 8.47 | 855 | 0.05 ± 0.01 | 0.22 ± 0.05 | Gasoline/sweet |
| o-Xylene | 8.81 | 888 | — | 0.37 ± 0.00 | — |
| α-Pinene | 11.25 | 937 | — | 0.16 ± 0.06 | Pine, woody |
| β-Pinene | 12.86 | 979 | — | 0.18 ± 0.03 | Pine, woody |
| 3-Carene | 13.98 | 1011 | — | 0.03 ± 0.01 | Citrus, sweet, herbal |
| D-Limonene | 14.70 | 1031 | — | 0.10 ± 0.01 | Citrus, sweet |
| 2-ethyl-Furan | 3.37 | 703 | 0.81 ± 0.20 | 8.36 ± 0.05 | Smoky, burnt |
| 2-pentyl-Furan | 13.36 | 993 | — | 0.06 ± 0.01 | Fruity, green |
| Trans-2-(2- | 13.68 | 1002 | — | 0.03 ± 0.01 | — |
| Pentenyl)furan | | | | | |
| Dimethylamine | 1.51 | 430 | 13.23 ± 1.10 | 13.73 ± 2.03 | Fish, ammonia |
| Trichloromethane | 2.41 | 615 | — | 2.44 ± 0.31 | Pleasant, sweet |

Referring to Table 2 and FIG. 2, the pet food according to the example essentially contained dimethylamine, ethyl acetate, and acetone as analyzed by GC-MS.

In contrast, the pet food according to Comparative Example 1 essentially contained pentane, 1-penten-3-ol, 2-ethyl-furan, and hexanal.

### Experimental Example 2: Physical Property Analysis

The pet foods prepared in Example and Comparative Example 1 were measured five times for the following physical properties using a texture analyzer (TAXT plus, Stable Micro Systems, Godalming, UK), and the average values were presented. The measurement conditions are shown in Table 3, and the results are presented in Table 4.

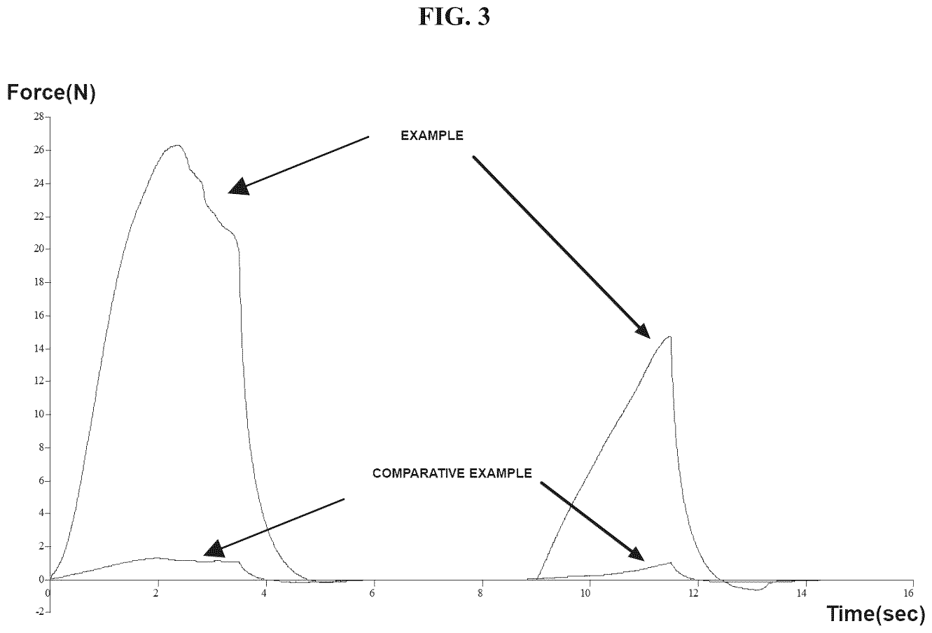

Graphs showing the hardness analysis results are additionally shown in FIG. 3.

TABLE 3

| Measurement | Condition | |
|---|---|---|
| Probe | 5 | mm P/5 |
| Pre-test Speed | 5.0 | mm/s |
| Test Speed | 2.0 | mm/s |
| Post-Test Speed | 5.0 | mm/s |
| Distance/Strain | 7.0 mm/s/50.0% | |
| Second distance | 60.0% | |
| Trigger Type | Auto | |
| Trigger Force | 5.0 | g |

TABLE 4

| | Hardness | Adhesiveness | Springiness | Cohesiveness | Gumminess | Chewiness | Resilience |
|---|---|---|---|---|---|---|---|
| Example | 2,665.0 ± 336.7 | −70.2 ± 59.1 | 0.9 ± 0.1 | 0.4 ± 0.1 | 1,184.2 ± 195.5 | 1,026.3 ± 217.3 | 0.1 ± 0.0 |
| Comparative | 141.9 ± 20.0 | −12.7 ± 13.1 | 0.9 ± 0.1 | 0.5 ± 0.1 | 63.9 ± 12.9 | 56.9 ± 15.3 | 0.1 ± 0.0 |
| Example 1 | | | | | | | |

Referring to Table 4, it was confirmed that the pet food according to the example has a hardness, a gumminess, and a chewiness of 1,000 gf or more. In particular, the hardness was measured to be 2,000 gf or more.

Referring to FIG. 3, it was confirmed that the hardness of the example was approximately 26 N.

In contrast, the pet food according to Comparative Example 1 was confirmed to have a hardness, a gumminess, and a chewiness of 1,000 gf or less. Comparative Example 1 was retorted without hot air drying, so its physical properties are expected to differ from those of the example.

### Experimental Example 3: Chromaticity Analysis

Chromaticity was measured using a colorimeter (CR-300 Chroma Meter, Minolta Inc., USA) for L (lightness), a (redness), and b (yellowness) values. The L, a, and b values of the standard white plate used were 97.59, −0.02, and 1.83, respectively. The average of three measurements was presented.

TABLE 5

| | L | a | b | ΔE (color |
|---|---|---|---|---|
| | (lightness) | (redness) | (yellowness) | difference) |
| Example | 53.9 ± 4.9 | 8.9 ± 2.3 | 18.2 ± 1.6 | 51.6 ± 4.6 |
| Comparative | 65.0 ± 2.3 | 7.9 ± 1.6 | 28.6 ± 1.7 | 65.5 ± 1.6 |
| Example 1 | | | | |

Referring to Table 5, the color of the pet food according to the example is closer to red, and since the color change is small, it can be expected that the freshness and quality are better than the pet food according to Comparative Example 1.

### Experimental Example 4: Hydrogen Ion Concentration Analysis

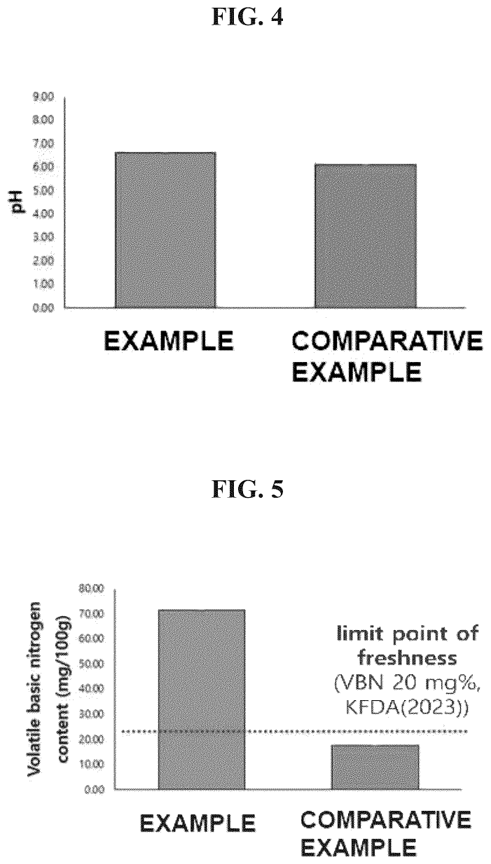

The hydrogen ion concentration of the pet foods prepared in Example 1 and Comparative Example 1 was analyzed using a pH meter (SevenEasy S20K, Mettler Toledo International Inc., Columbus, OH, USA). The results are shown in FIG. 4.

Referring to FIG. 4, it can be seen that the pet food according to the example has excellent freshness, with a pH of 6.3 or higher.

### Experimental Example 5: VBN Analysis

The VBN of the pet foods prepared in Example 1 and Comparative Example 1 was analyzed using the Conway microdiffusion method (Conway, 1958). A boric acid absorbent and a test solution were placed in the inner and outer chambers, respectively, and then saturated potassium carbonate was injected into the outer chamber. The Conway dish was quickly fastened with a clip and placed in an incubator for 80 minutes at 37° C. After incubation, the food was titrated with 0.01 N-NaOH, and the resulting value was calculated as the VBN value (mg/100 g). The results are shown in FIG. 5.

Referring to FIG. 5, the VBN value is 50 mg % or higher, indicating that the measured VBN is a significant value that stimulates the olfactory sense of companion animals and enhances their palatability.

Considering the results of Experimental Example 7 described below, it was confirmed that the VBN value is a negative factor in human food, but can be a factor that stimulates palatability from the perspective of companion animals.

### Experimental Example 6: Microbial Count Analysis

A portion (10 g) of the pet foods according to Example and Comparative Example 1 was diluted 10-fold with sterile water and spread on a dry film medium (Petri film, 3M, USA). The samples were cultured at 35° C. for two days, and the resulting colonies were counted and expressed as CFU/g. The results are presented in Table 6.

TABLE 6

| | Aerobic | Coliform |
|---|---|---|
| | count | count |
| | (AC) | (CC) |
| Example | ND | ND |
| Comparative | ND | ND |
| Example 1 | | |

*ND—not detected

Referring to Table 6, as a result of retort processing, neither general bacteria nor E. coli were detected in the pet foods according to the examples and comparative examples.

### Experimental Example 7: Confirmation of Pet Food Preference 1

To determine pet food preference, 100 companion dogs were divided into groups of ten. For each group, the pet food according to Example and Comparative Example 1 was evaluated using a 4-point scale as follows. Each value was expressed as the average. The results are presented in Table 7.

### <Preference Evaluation Criteria>

1 point: Low access and interest shown by the dogs, or no difference in intake.

2 points: High access and interest shown by the dogs, but no difference in intake.

3 points: High access and interest shown by the dogs, and smooth intake.

4 points: High access and interest shown by the dogs, and intense competition for intake.

TABLE 7

| | Preference |
|---|---|
| | (average) |
| Example | 4.0 |
| Comparative | 2.6 |
| Example 1 | |

Referring to Table 7, it can be confirmed that the pet food according to Example has a higher preference for companion animals than the pet food according to Comparative Example 1. Therefore, it can be seen that the pet food according to Example stimulates both the olfactory and texture senses of companion animals, thereby improving the preference compared to existing pet foods.

### Experimental Example 8: Confirmation of Pet Food Preference 2

To determine the preference for pet food, 10 companion dogs and 10 companion cats were prepared, and their preferences for pet food according to Example and Comparative Example 2 were investigated on a 1:1 basis.

TABLE 8

| | Dogs | Cats |
|---|---|---|
| Example | 8 | 9 |
| Comparative | 2 | 1 |
| Example 2 | | |

Referring to Table 8, both dogs and cats showed a higher preference for the pet food according to Example than for the pet food according to Comparative Example 2. The pet food according to Comparative Example 2 is expected to be much harder than the pet food of Example, resulting in inferior olfactory and texture qualities.

A pet food according to an exemplary embodiment exhibits excellent palatability for companion animals. For example, since an amine compound, an acetate compound, and an acetone compound is detected when measured using a gas chromatography-mass spectrometer, the pet food can stimulate olfactory sense of companion animals, thereby improving the palatability. For example, the pet food exhibits a hardness, a gumminess, and a chewiness of 1,000 gf or more based on texture profile analysis, thereby stimulating the sense of taste and enhancing palatability of companion animals.

A pet food according to an exemplary embodiment exhibits superior taste and nutrition. For example, it can minimize nutrient loss by maintaining the original form of the aquatic product and transparently provide the ingredients contained therein.

The pet food production method according to an exemplary embodiment can extend the shelf life of the pet food. For example, the retort process can extend the shelf life by several months.

All embodiments and conditional examples disclosed herein are intended to help those skilled in the art understand the principles and concepts of the present invention. Those skilled in the art will appreciate that the present invention can be implemented in modified forms without departing from the essential characteristics thereof. Therefore, the disclosed embodiments should be considered in an illustrative perspective rather than a restrictive perspective. The scope of the present invention is set forth in the claims, not the foregoing description, and all differences within the scope equivalent thereto should be construed as being included in the present invention.

1. A pet food comprising an aquatic product, wherein an amine compound, an acetate compound, and an acetone compound are detected when measured using a gas chromatography-mass spectrometer.

2. The pet food according to claim 1, wherein the amine compound includes at least one selected from methylamine, ethylamine, butylamine, hexylamine, dimethylamine, diethylamine, dibutylamine, and trimethylamine.

3. The pet food according to claim 1, wherein the acetate compound includes at least one selected from methyl acetate, ethyl acetate, propyl acetate, butyl acetate, isoamyl acetate, and benzyl acetate.

4. The pet food according to claim 1, wherein a sulfide compound is further detected.

5. The pet food according to claim 4, wherein the sulfide compound includes at least one selected from dimethyl sulfide, diethyl sulfide, methyl ethyl sulfide, dimethyl disulfide, diallyl sulfide, and diphenyl sulfide.

6. The pet food according to claim 1, wherein the aquatic product contains no other ingredients.

7. A pet food comprising an aquatic product, the pet food having a hardness, a gumminess, and a chewiness of 1,000 gf or more based on a texture profile analysis.

8. A method of producing a pet food, comprising:
a step of first freezing an aquatic product;
a step of thawing the frozen aquatic product;
a step of hot-air drying the thawed aquatic product;
a step of secondarily freezing the hot-air dried aquatic product; and
a step of retorting the secondarily frozen aquatic product.

9. The method according to claim 8, wherein the hot-air drying is carried out at 50 to 70° C. for two to five hours.

10. The method according to claim 8, wherein the step of retorting is carried out at 110 to 130° C. for one to three hours.
